(19) United States
(12) Patent Application Publication
(10) Pub. No.: US 2015/0302536 A1
(43) Pub. Date: Oct. 22, 2015

(54) VIRTUAL INFORMATION PRESENTATION SYSTEM

(71) Applicants: Jeffrey R. WAHL, (US); Francis PAPAY, (US)

(72) Inventors: Jeffrey R. Wahl, Pepper Pike, OH (US); Francis Papay, Westlake, OH (US)

(21) Appl. No.: 14/435,280

(22) PCT Filed: Oct. 11, 2013
(86) PCT No.: PCT/US13/64702

§ 371 Date: Apr. 13, 2015

Related U.S. Application Data
(60) Provisional application No. 61/712,618, filed on Oct. 11, 2012.

(51) Int. Cl. G06Q 50/22; G06F 19/00

(52) U.S. Cl. CPC G06Q 50/22; G06F 19/3418; G06F 19/3425

(57) ABSTRACT

Systems, methods and computer-readable storage media for presenting a virtual information presentation to a user are described. A virtual information presentation system may be configured to present an information presentation process to a user configured based on an objective, a subject and/or information associated with the user. For example, an objective may include obtaining consent for a medical procedure or a clinical research project. In another example, an objective may include confirming user understanding of a particular subject, such as job training. The information may be presented using lifelike avatars and other graphic elements to immerse the user in the information presentation process.

### BACKGROUND

Health care providers and medical research organizations must conform to certain state and professional standards in order to be able to provide medical care or perform clinical studies. One example involves apprising potential patients and research participants of certain medical information, such as the risks and possible outcomes, including negative outcomes, involved in a medical procedure, diagnostic test, or clinical study. In addition, health care providers and medical research organizations must be able to verifiably demonstrate that they adequately explained the information to a patient.

Informed consent is one method for demonstrating that a patient received the information necessary for them to make an informed medical decision. In general, informed consent is permission granted by a patient to a medical or research organization to undergo a medical procedure or participate in a clinical study after learning and understanding the relevant medical facts, costs, and risks. The elements of informed consent generally include informing the patient of the nature of the procedure or study, available alternatives, and the risks and benefits of the procedure or study. The patent must be competent and the permission granted voluntarily in order for an informed consent to be valid. In general, the informed consent process involves providing the patient with a consent document consisting of complex medical and legal information related to the procedure or participation in the study. The information in the consent document is usually explained to the patient by medical or clinical personnel and the patient provides consent by signing the consent document.

A legitimate informed consent serves multiple purposes. From the patient's point of view, the informed consent procedure is aimed at identifying and respecting their best interests by giving than the information to autonomously decide whether they should undergo a medical procedure or participate in a clinical study. Medical and research organizations benefit from the information presentation process because it provides verification that the patient clearly understood the risks and potential negative outcomes. For example, medical malpractice and pharmaceutical research litigation costs billions of dollars annually and a large majority of malpractice cases involve informed consent issues. Accordingly, a properly obtained informed consent may operate to the malpractice and litigation exposure of health care providers and medical research organizations. More importantly, however, health care providers, medical research organizations, and patients all benefit when medical procedures and clinical studies are performed with and knowledgeable participants that will benefit from them.

Although it is one of the most important steps before commencing a medical procedure or clinical study, the typical informed consent procedure is inefficient and is not readily verifiable. For instance, standard written consent forms are inadequate to fully validate patient understanding of the choices and risks involved in a proposed procedure or study. Consent forms generally include many subtle and complex legal and medical concepts. They may often be written at a reading level that is beyond the capacity of the patients that must read and understand them. In addition, it is costly and time consuming for medical and clinical personnel to fully explain a consent form to a patient. As such, health care providers and medical research organizations may not have the resources to ensure that patients understand the contents of the consent form. Thus, many potential patients and study participants end up signing consent forms that they do not fully understand.

### SUMMARY

This disclosure is not limited to the particular systems, devices and methods described, as these may vary. The terminology used in the description is for the purpose of describing the particular versions or embodiments only, and is not intended to limit the scope.

As use in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a virtual information presentation system may include a processor and a non-transitory, computer-readable storage medium in operable communication with the processor. The computer-readable storage medium may contain one or more programming instructions that, when executed, cause the processor to generate an information presentation process comprising a plurality of information elements, the information presentation process being configured based on an objective and at least one subject, generate at least one virtual agent comprising at least one virtual agent characteristic, the at least one virtual agent characteristic being configured based on at least one of the objective and the at least one subject, present the information presentation process using the virtual agent, and receive user input comprising at least one presentation response.

In an embodiment, a computer-implemented method for presenting an information presentation process to a system user may comprise, by a processor generating an information presentation process comprising a plurality of information elements, the information presentation process being configured based on an objective and at least one subject, generating at least one virtual agent comprising at least one virtual agent characteristic, the at least one virtual agent characteristic being configured based on at least one of the objective and the at least one subject, presenting the information presentation process using the virtual agent and receiving user input comprising at least one presentation response.

In an embodiment, a computer-readable storage medium may have computer-readable program code configured to present an information resonation process embodied therewith. The computer-readable program code may comprise computer-readable program code configured to generate at least one virtual agent comprising at least one virtual agent characteristic, the at least one virtual agent characteristic being configured based on at least one of the objective and the at least one subject, computer-readable program code configured to present the information presentation process using the virtual agent, and computer-readable program code configured to receive user input comprising at least one presentation response; and,

In an embodiment, a virtual information presentation may comprise a processor and a non-transitory, computer-readable storage medium in operable communication with the processor. The computer-readable storage medium may contain one or more programming instructions that, when executed, cause the processor to generate an information presentation process configured to obtain consent from a patient to undergo a medical procedure or participate in clinical research, generate at least one virtual agent configured as a healthcare professional or clinical researcher, present the information presentation process using the virtual agent, and receive user input indicating whether the patient consents to undergo the medical procedure or participate in the clinical research.

### BRIEF DESCRIPTION OF THE FIGURES

FIG. 1 depicts an illustrative virtual information presentation system according to some embodiments.

FIG. 2 depicts an illustrative virtual information presentation application according to some embodiments.

FIG. 3 depicts illustrative avatar according to some embodiments.

FIG. 4 depicts a flow diagram for an illustrative method for an information presentation process according to some embodiments.

FIG. 5 depicts illustrative computing device internal hardware according to some embodiments.

### DETAILED DESCRIPTION

The described technology generally relates to a virtual information presentation system (the “presentation system”). In one aspect, some embodiments provide for a virtual environment that includes a virtual agent (for example, an “avatar,” “embodied conversational agent,” “relational agent” and/or the like) operative to interactively present an information presentation process to a patient. The information presented in the information presentation process may comprise various information elements, including medical and/or research information elements, such as medical procedure, diagnostic test, and clinical research (for example, drug trial) information. The virtual environment may be presented to a patient on a display device in operative communication with a computing device. The patient may interact with the virtual environment, such as by answering questions, through one or more input devices configured to provide input to the computing device.

Although some embodiments and illustrative examples generally relate to information relating to medicine, healthcare, clinical research, or the like, embodiments are not so limited. Indeed, a virtual information presentation system may be configured according to some embodiments to operate using any type of information, including information relating to the law, mortgage applications, college applications, real estate transactions, computing device training, employee training, retail transactions, educational sessions, or the like.

According to some embodiments, the virtual information presentation system may operate to provide information to a patient associated with a medical procedure, diagnostic test, and/or clinical study and to assess the patient's understanding of the information. In some embodiments, the virtual information presentation system may comprise various information presentation packages or processes configured for a particular medical procedure, diagnostic test, clinical study, pharmaceutical study or prescription, or other medical/health related processes.

In some embodiments, the information presentation process may include various information elements that are presented to a user. In some embodiments, the information presentation process may be configured based on one or more subjects, including a medical procedure, an educational topic (for instance, employee safety, an employee job function, an educational topic, or the like), a research process, or the like. In some embodiments, the information presentation process may be configured based on one or more objectives, including obtaining consent, obtaining permission, education, training, acknowledging understanding, demonstrating understanding, or the like.

In some embodiments, the information presentation process may include an informed consent process including a consent objective and a medical procedure subject. The information presentation process may be configured according to one or more informed consent protocols, for instance, developed by a system operator or accessed from a database. For example, different informed consent protocols may be created based on the type of medical procedure, clinical study, applicable laws and/or guidelines, under or for which consent is to be given. An illustrative set of guidelines includes the Food and Drug Administration (FDA) guidelines provided in Title 21 of the Code of Federal Regulations at Sec. 50.20, entitled “General requirements for informed consent.” In some embodiments, the informed consent process may be a dynamic process configured to proceed based on one or more patient characteristics. The patient characteristics may be based on available demographic information or learned through patient feedback during the informed consent process. For example, the virtual interactive informed consent system may operate to tailor the informed consent process based on the health literacy of the patient as indicated by patient feedback.

The foregoing summary is illustrative only and is not intended to be in any way limiting. Although an informed consent process is used as an illustrative information presentation process in the foregoing summary and following detailed description, embodiments are not so limited, as any information presentation process capable of operating according to embodiments is contemplated herein. In addition to the illustrative aspects, embodiments, and features described above, further aspects, embodiments, and features will become apparent by reference to the drawings, wherein like reference numerals are used to refer to like elements throughout, and the following detailed description.

The present disclosure is generally directed to a virtual information presentation system configured to provide information to and/or receive information from a patient before undergoing a medical procedure, such as elective plastic surgery, a diagnostic test, such as a computed tomography (CT) scan, or participating in a clinical study, such as a clinical trial of a new drug. The virtual information presentation system may include a computer-implemented system for interactively presenting medical information to a user through a virtual agent (for example, an “avatar,” “embodied conversational agent,” “relational agent,” and/or the like), assessing patient understanding, and/or providing validation of patient consent. The terms “virtual agent,” “avatar,” “embodied conversational agent” or “relational agent” may be used interchangeably herein. In some embodiments, the information presentation process may be configured based on one or more objectives, including obtaining consent, obtaining permission, education training, acknowledging understanding, demonstrating understanding, or the like. In some embodiments, the virtual information presentation system may be configured to present an information presentation process to users through an avatar and to receive a presentation response from the user. In some embodiments, the presentation response may include an acknowledgement, indication of understanding, consent, user signature, permission, or other response from a user associated with the purpose of the information presentation process.

Health care providers and medical research organizations have recognized the benefits of using technology to interact with patients. However, face-to-face encounters with medical personnel remain an extremely effective method for communicating health information to patients. As such, some embodiments provide that the avatar may include a highly realistic human representation that is able to recreate many facets of the traditional patient-medical personnel encounter. For example, the avatar may include a life-like representation of a medical staff member that is able to communicate with a patient using natural language processing and to interact in a give-and-take manner that realistically mimics normal conversation. Accordingly, the virtual information presentation system may provide a dynamic, computerized information presentation process while maintaining many of the features of everyday human interaction that patients prefer.

In some embodiments, the information presentation process may involve a computer-implemented process of interactively presenting information to a patient in some embodiments, the information presentation process may be configured according to one or more objectives of the information presentation process such as education, training, obtaining consent, acknowledgement of understanding. In some embodiments, the information presentation process may be configured to obtain a presentation response from a user associated with the objective, including a consent, permission and/or an indication of understanding of certain information in the information presentation process.

According to some embodiments, the information may include medical information such as relevant information associated with a medical procedure, diagnostic test, and/or clinical study. For example, an information presentation process may be directed toward educating patients about post-operative care. In another example, an information presentation process may involve receiving feedback from patients regarding certain courses of treatment. In a further example, an information presentation process may include capturing the degree of patient understanding of a treatment regimen. In a still further example, an information presentation process may include fully disclosing to a patient all of the relevant information necessary to allow the patient to make a voluntary and informed decision to undergo a medical treatment (for instance, a risk presentation process), diagnostic test, and/or participate in a clinical study, determining whether the patient provides consent, and verifying consent. Fully disclosing information may involve presenting information, for instance, through digital documents, videos and/or audio, to the patient in a manner that they may comprehend.

Although the virtual information presentation system may be described with reference to an informed consent process herein, embodiments are not so limited, as the informed consent process merely serves as an illustrative and non-restrictive example. Any information presentation processes capable of operating according to some embodiments are contemplated in this detailed description, including, without limitation, legal, mortgage applications, college applications, real estate transactions, computing device training, employee training, retail transactions, educational sessions, or the like.

The information presentation processes described herein provide multiple technological advantages. One non-limiting technological advantage is to increase the efficiency and cost-effectiveness of operations that rely on information presentation, such as entities that require patient consent for medical and research purposes. For example, certain personnel, such as physicians and anesthesiologists may spend more time performing their professional medical duties instead of implementing information presentation processes. In another example, resources, such as operating rooms and diagnostic testing equipment, may be used more economically because patient processing may occur faster and more efficiently.

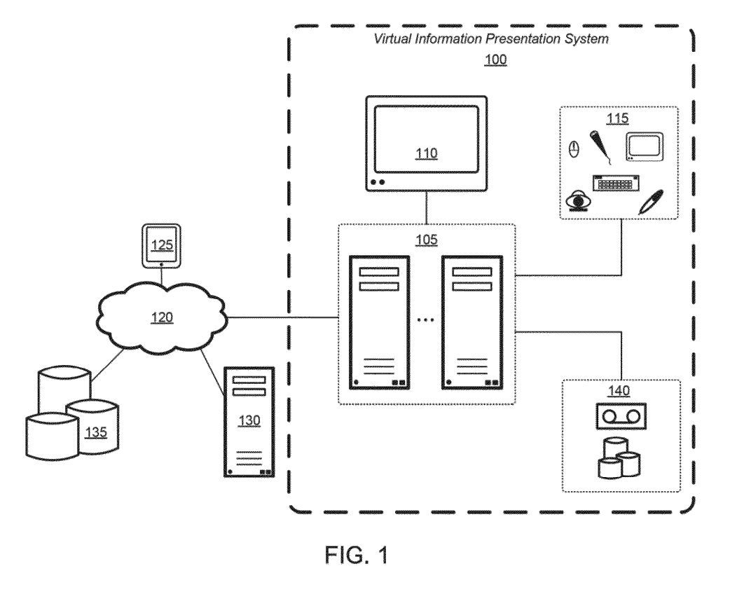

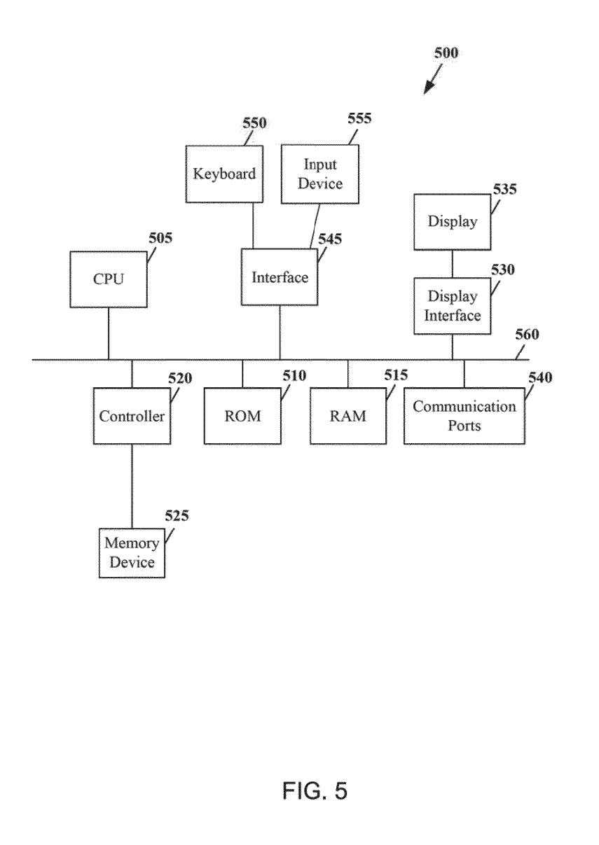

FIG. 1 depicts an illustrative virtual information presentation system 100 according to some embodiments. As shown in FIG. 1, the virtual information presentation system 100 may include one or more computing devices 105 in operative communication with a display device 110. Computing device 500 of FIG. 5 provides an illustrative computing device. According to some embodiments, the computing devices 105 may include servers, personal computers (for example, PCs or workstations), laptops, mobile computing devices, smartphones, personal digital assistants (PDAs), tablet computing devices, or any combination thereof. One or more input devices 115 may be operatively connected to the computing devices 105 for providing user input. Non-limiting examples of input devices 115 include a computing device 105, mouse, keyboard, touch screen, stylus, camera, and microphone. In some embodiments, the display device 110 may be a touch screen input device. The virtual information presentation system 100 may use one or more of the input devices 115 to receive input from the patient and to verify the input (for example, verify communication of the information, verify consent, etc.).

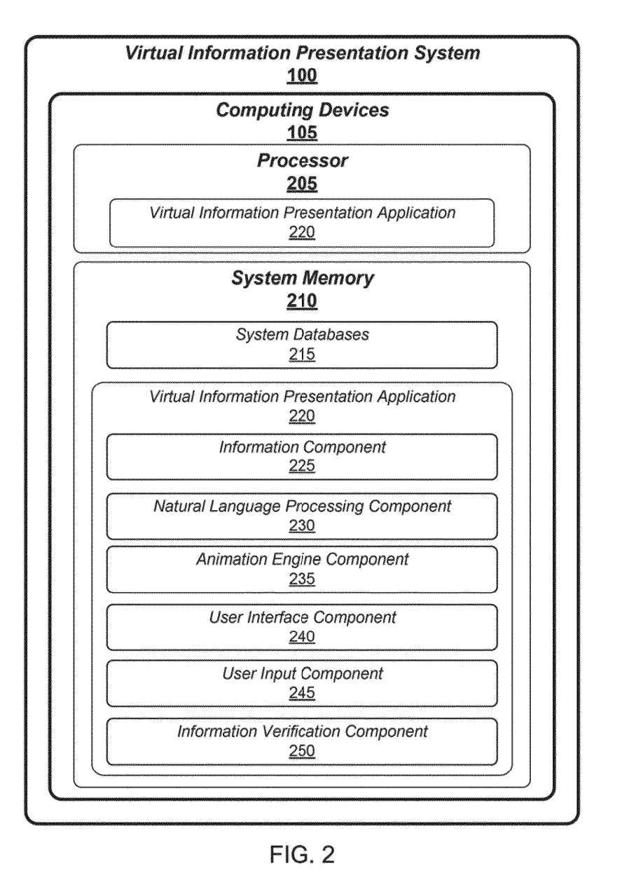

The computing devices 105 may execute a virtual information presentation application (“presentation application”) (see FIG. 2). The virtual information presentation application may be operative to implement, among other things, a virtual environment for the information presentation process. The virtual environment may include various visual elements, such as avatars, graphical user interface (GUI) elements, files, selection elements (for example, virtual buttons, switches, etc.), and multimedia presentations (for example, video and/or audio presentations).

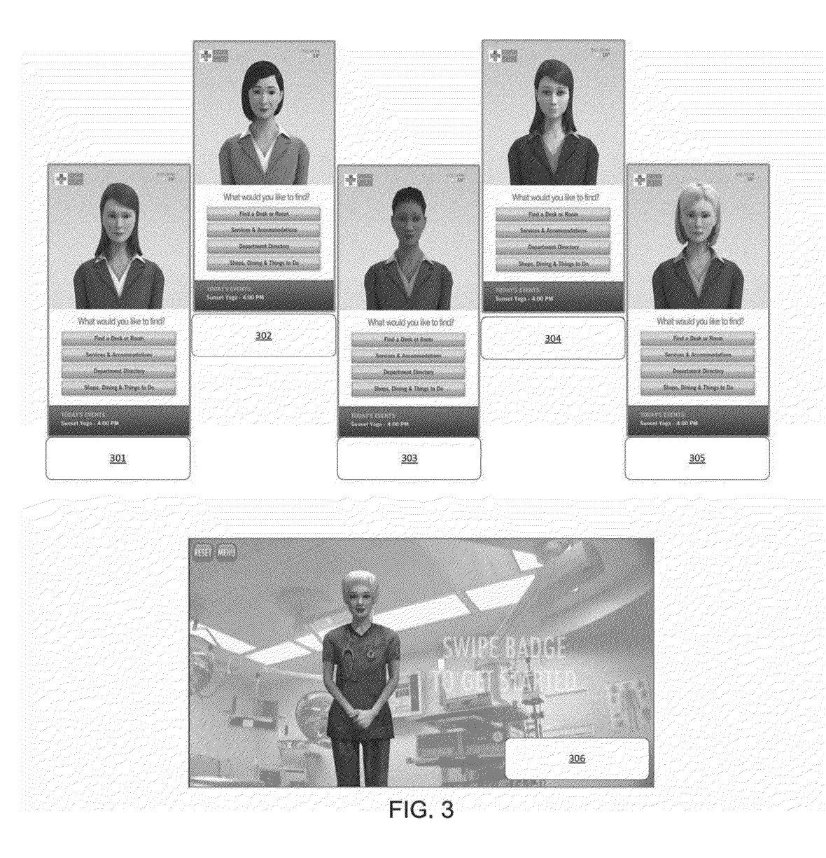

According to some embodiments, the virtual information presentation application may be configured to generate the visual elements based on one or more contextual characteristics including, without limitation, characteristics associated with the patient, the healthcare facility and/or clinical research site, the medical procedure, the clinical study, applicable laws and/or guidelines, and any combination thereof. For example, the avatar may be configured to have various physical features (see FIG. 3) that may be determined based on the contextual characteristics. An illustrative and non-restrictive example provides that a male avatar may be used for male patients while a female avatar may be used for female patients, or vice versa. In another illustrative and non-limiting example, a younger looking avatar may be used for younger patients while an older avatar may be used for older patients and/or for major non-elective surgical procedures. In a further illustrative and non-limiting example, the clothing for the avatars may depend on the contextual characteristics. For example, the avatars may be dressed in white lab coats over street clothes for a clinical research setting and in a nurse uniform (or “scrubs”) in a healthcare facility. In addition, the name and/or logo of the healthcare facility or clinical site may be located on the clothing.

In some embodiments, the virtual information presentation system may use multiple avatars. In some embodiments, the multiple avatars may include one “main” avatar and one “alternative” or “companion” avatar. In some embodiments, the main avatar may be configured to perform an information presentation process described according to some embodiments, and the companion avatar may be configured to perform certain auxiliary or additional functions. In a non-limiting example in which a first user (for instance, a parent or guardian) is experiencing an information presentation process on behalf of a second user (for instance, a child, minor, or the like), the main avatar may be used to perform the information presentation process, and the companion avatar may be used to entertain and/or answer questions that may be more appropriate for the second user. For instance, for a pediatric procedure, the main avatar may be used in an information presentation process to obtain consent from the parents of the child undergoing the procedure, and the companion avatar may be used by the child to take a virtual tour of the facility, explain the procedure in terms that may be more appropriate for a child, explain where their parents will be during the procedure, and/or entertain the child. In some embodiments, the main avatar may be used in a first information presentation executed on a first computing device (for instance, a PC, kiosk computing device, or the like), while the companion avatar may be used in a second information presentation on a second computing device (for instance, a tablet computing device, smartphone, a PC, a laptop, or the like).

In some embodiments, the virtual information presentation application may be configured to provide messages to users associated with the system. For example, the virtual information presentation application may send follow-up messages, requests for information, or the like. In some embodiments, the messages may include text messages, electronic mail (e-mail) messages, voice messages, or the like. In some embodiments, the messages may include avatars and/or characteristics thereof (for example, the voice of an avatar). In some embodiments, the messages may include audio-visual files or components that may be played via a user computing device. In this manner, the virtual information presentation system may send messages to users that include avatars or other aspects of the information presentation process according to some embodiments.

In some embodiments, the avatar may be configured such that it does not resemble a doctor, senior clinical staff member, or other licensed health professional in order to avoid certain adverse representations. For example, the avatar may preface certain statements by stating that they were “asked by your doctor to give you some information about the surgery, and to make sure you understand important issues,” “I work in the department of plastic surgery,” or other establishing statements.

In some embodiments, the appearance of the avatar may be arranged such that the avatar predominates the informed consent encounter, facilitates sustained attention, establishes trust, and is neutral on coercion issues. For example, the voice of the avatar may be heard throughout the information presentation process, even if the avatar is not visible on the screen (such as when a document, video, or text is the predominant visual element). In this manner, the avatar may operate to simulate the patient/provider encounter, encouraging trust and confidence in the system and the healthcare or clinical research team it represents.

In this manner, the virtual information presentation application may be configured to provide patients with an immersive user experience in that the presentation system may fully capture the attention of the patient and, for example, provide a distraction from the fears, concerns and anxieties of the upcoming procedure or research. Accordingly, the presentation system may be configured to immerse the user through, among other things, lifelike avatars with realistic voice and movements.

The computing devices 105 may be in communication with one or more networks 120, such as a local area network (LAN), wide area network (WAN), distributed computing environments (for example, a cloud computing environment), and combinations thereof. Through the networks 120, the computing devices 105 may access databases 135 and external servers 130 (for example, data servers and web servers) that may store information used by the virtual information presentation application. For instance, the virtual information presentation application may access and/or store files and information in the databases 135 and/or external servers 130. In some embodiments, the computing devices 105 may be in communication over the network with one or more health information systems, such as a healthcare information and management system (HIMS), an electronic medical record (EMR) system, a radiology information systems (RIS), a picture archiving and communication system (PACS), and/or the like, for storing files, records, and information associated with the patient and the information presentation process.

In some embodiments, a patient may access the virtual information presentation system 100 through physical access to a computing device 105, for example, at a doctor's office, health care facility, or research clinic. In another embodiment, a patient may access the virtual information presentation system 100 through a client computing device 125 configured to communicate with a computing device 105 through the network 120. In this embodiment, the virtual environment may be implemented by the virtual information presentation application on a server 105 for presentation on a display device operatively connected to the client computing device 125. For instance, the client computing device 125 may access the virtual information presentation application through the Internet as a web-based application or locally through a mobile application (for example, “mobile app” or “app”). Illustrative and non-restrictive examples of client computing devices 125 include servers, PCs, mobile computing devices, smartphones, personal digital assistants (PDAs), laptops, and tablet computing devices. In this manner, user may use the virtual information presentation application in their home, for example, remote from a hospital, healthcare facility, research facility or the like where a procedure or research may actually take place. In addition, users may complete some or all of an information presentation process and/or consent process before arriving at the location where the procedure or research may actually take place.

According to some embodiments, a patient may be provided access to the virtual information presentation system 100 before undergoing a medical procedure, diagnostic test, or participating in a clinical study. The virtual information presentation application may initiate the information presentation process by generating an avatar and background appropriate for the context of the encounter, including the objective and/or subject of the information process and system user information. In some embodiments, context may include default aspects as well as aspects based on patient information. For example, the system user information may include certain demographic information (for example, name, gender, age, address, education) and medical information (for example, health history, type of procedure) may be known before the information presentation process is initiated and serve as context. Some embodiments provide that the virtual information presentation application may generate an information presentation process based on the same and/or additional information. For instance, the computing devices 105, 130 and/or databases 135 may store one or more informed consent documents, forms, questionnaires, scripts, and combinations thereof. The visual elements in combination with the information presentation process may be presented to the user to explain the benefits, alternatives, and risks of the procedure or clinical study.

According to some embodiments, the information presentation process may advance through a series of steps configured to provide the necessary information to the patient, to receive input from the user in response to certain questions and/or requests, and to receive verified consent or non-consent to the procedure or clinical study. The virtual information presentation system 100 may be configured to present the information presentation process such that the virtual information presentation system “drives” the system. In some embodiments the patient may not directly control at least some of the flow and pace of the information presentation process from the outset. However, some embodiments provide that the user may make modifications to the process, such as pausing the process or replaying a particular section.

In some embodiments, the information presentation process is dynamic and may change based on the input received from the user. For example, the virtual information presentation application may present one or more questions to the user to gauge their health literacy, and the user may answer by making a selection, for instance, by using a mouse, by speaking an answer into a microphone, or by making a selection on a touch screen. The virtual information presentation application may take the input and make a patient health literacy determination. For example, if the patient has relatively high health literacy, the virtual information presentation application may tailor the information presentation process for high health literacy.

In some embodiments, the information presentation process, such as an informed consent session, may be recorded, for example, using a video camera and microphone input devices 115 and/or virtual information presentation application modules configured to record user input and the corresponding point in the information presentation process. In this manner, an operator may verify consent or lack thereof, use the information to revise or standardize the information presentation process, and/or maintain the informed consent session as part of the patient medical record.

In some embodiments, the information presentation process may notify that the session is being recorded and any reasons for the recording (for example, family review, data retention purposes, quality patient care processes, verification of consent, or the like). In addition, the information presentation process may inform the patient whether the recording complies with certain guidelines (for example, the Health Insurance Portability and Accountability Act (HIPAA)) and provide a selection for the patient to choose whether or not they would like to be recorded. In some embodiments, if the user chooses to not allow the session to be recorded, the information presentation process may then continue without recording or inform the patient that recording is a required part of the consent process.

In some embodiments, the patient may elect to view themselves being recorded by a camera during the information presentation process, for example, in a split-screen (for instance, one side including the information presentation process, the other side including the video of the patient) or a video window located within the virtual environment. In another embodiment, the user may elect whether to include the video in a recording of the user input and corresponding information presentation process. In a further embodiment, the information presentation process may be recorded alone or with the video recording. In this manner, a doctor or other interested party may have access to the consent process as well as a recording of the user as they advanced through the information presentation process. As described herein, the informed consent recording, the video recording, and combinations thereof may be saved by the illustrative virtual information presentation system. For example, the informed consent recording and video recording may be saved as a digital file, such as a multimedia file. The digital file may be stored within the illustrative virtual information presentation system, in a health information system, such as a PACS system, other storage location (for instance, a network, a server computing device, a cloud computing environment), or some combination thereof. Some embodiments provide that the digital file may be made a part of the patient records stored in a PACS system or other health information system. In some embodiments, the informed consent and the video recording may be stored as separate files that may be associated by the illustrative virtual information presentation system (for example, using metadata or other identifier) or other storage system.

As shown in FIG. 1, the virtual information presentation system 100 may include a recorder module 140. The recorder module 140 may be configured to manage the recording of aspects of patient interaction with the virtual information presentation system 100 and the storage of data and files associated with the recording. In some embodiments, the recorder module 140 may record the entire information presentation process, including user interaction with the virtual information presentation system 100 during the information presentation process. For example, the recorder module 140 may operate to record the sequence of information and GUI elements presented to the patient and patient responses thereto. The recorded sequence may be stored as a file or multimedia file, including in a quasi-movie format such that the recorded sequence may be viewed and “played back.” For instance, a medical staff member may “play” the recorded sequence to view what information was presented to the user, how it was presented, and what responses were provided by the user.

In some embodiments, the recorder module 140, or some other module or device accessible by the presentation application, may include a timing element configured to track the time associated with a recorded information presentation process. In this manner, each event (for instance, presentation of information and request for patient to acknowledge understanding) within the information presentation process may be timed and used as a metric to measure patient interaction and knowledge acquisition.

In some embodiments, the recorder module 140 may be configured to manage the video recording of patients interacting with the virtual information presentation system 100. For example, the recorder module 140 may be configured to video record patient interaction with the system such that the recorded sequence of information and GUI elements presented to the user and the video recording may be synchronized and played back together. For example, the recorded information presentation process may be played back or viewed live as a split screen or moveable video window (for instance for example, what the patient was doing, what the patient was seeing, and/or video of the patient during this process) or as a single screen displaying what the user was seeing along with corresponding recorded audio. In this example, the recorder module 140 may operate to maintain time information and/or to merge the recorded information (such as video, graphical, textual, and/or user response information) into one or more files that may be accessed to generate a synchronized, unitary viewing experience of the information presentation process. In some embodiments, the recorder module 140 may operate to record interactions between the patient and doctor (or other professional, such as a clinical researcher). This patient-doctor recording may be included in the recorded patient record of the information presentation process and may be accessed by various methods known to those having ordinary skill in the art, such as through the Internet (for example, as a “download”), compact disc (CD), digital video disc (DVD), Blu-ray disc™, flash drive, and the like.

According to some embodiments, the information presentation process may be initiated by presenting the user with an avatar that generally describes the information presentation process and its significance. In some embodiments, the avatar may then conduct a pre-encounter function that is configured as a mini-assessment of the patient before the presentation of the substantive informed consent material. For example, the pre-encounter function may operate to quickly and effectively test the patient's ability to understand speech as delivered by the system (for example, substantially natural computer-implemented human speech or pre-recorded human speech), that the user has the appropriate neurosensory capacity to respond to commands from the system, and/or that the user has the minimum acceptable motor capacity to execute the response gestures (such as mouse clicks, keyboard selections, touch gestures, vocal commands, etc.) required for the information presentation process.

For example, the pre-encounter function may determine that a user has below-average hearing such that they would benefit from a textual presentation of at least some of the words spoken by the avatar. In another example, the pre-encounter function may determine that it is more efficient for a user to speak question responses and interpret the responses with a speech recognition module than to use a mouse, keyboard, touch screen input device, or other input device. In this manner, patients who could not otherwise adequately interact with the virtual information presentation system or some part of the system may be managed efficiently and may still obtain a useful and positive user experience. For example, these patients may be removed from the virtual information presentation application and selected for an information presentation process with a medical staff member. In another example, these patients may continue with the information presentation process supervised, either remotely or locally, by a medical staff member.

As described herein, the virtual information presentation system 100 may be configured to improve and promote shared decision-making for medical procedures and clinical trials. In this manner, the virtual information presentation system 100 may operate to improve the overall patient experience and to enable higher quality and more cost-effective health care and clinical studies. For example, physicians, researchers, and staff may attend to higher-value functions and providing quality medical care instead of spending time on informed consent procedures, essentially unburdening medical and research provider time. In addition, the virtual information presentation system 100 may be configured to produce stronger consents by, among other things, providing standardize information presentation processes, provide scientifically validated patient consents, and create information presentation processes that respond to variations in literacy, numeracy, and cultural differences.

In some embodiments, access to the virtual information presentation system 100 and components thereof may be configured to comply with various local, state, federal, and/or professional guidelines or laws. For example, the virtual information presentation system 100 may be configured to collect information and provide access to information according to HIPAA.

According to some embodiments, the virtual information presentation system 100 may be configured to operate in different countries and to interact with patients of various nationalities, cultures, languages, and ethnicities. In some embodiments, a patient may be given an option to select one or more preferred cultural and/or national characteristics. In another embodiment, the virtual information presentation system 100 may automatically select one or more preferred cultural and/or national characteristics based on, for example, the location or population dynamics of patients associated with the medical procedure, diagnostic test, or clinical study. Some embodiments provide that the virtual information presentation system 100 may operate to use medical information, graphical elements, and avatars (and avatar characteristics) appropriate for the culture, language, location, and population. In this manner, the virtual information presentation system 100 may dynamically operate to provide medical information to a global audience.

FIG. 2 depicts an illustrative virtual information presentation application 220 according to some embodiments. As shown in FIG. 2, the virtual information presentation system 100 may include one or more computing devices 105 having a system memory 210 and a processor 205. The system memory 210 may store one or more system databases 215 a virtual information presentation application 220 arranged for execution by the processor 205 to present a virtual environment for an information presentation process configured according to embodiments described herein.

The system databases 215 may include any information source accessible by the virtual information presentation system 100, the virtual information presentation application 220, and/or components thereof. In some embodiments, the system databases 215 may include local databases, electronic files, third-party databases, or any other source of information now known to those having ordinary skill in the art or developed in the future. In some embodiments, the system databases 215 may include information associated with system users, including patients and personnel associated with entities operating the virtual information presentation system 100, such as a hospital, healthcare facility and/or research facility (including, for example, doctors and researchers). For example, the system databases 215 may include or may have access to patient medical information, prescription information, surgery information, mental health information, research participation information, or the like.

In some embodiments, the virtual information presentation application 220 may be configured to locate information for inclusion in the system databases 215. For instance, the virtual information presentation application 220 may search internal information sources and/or external information sources (for example, the Internet, LANs, WANs, third-party information sources) for information for inclusion in the system databases 215. For example, the virtual information presentation application 220 may search for information, including public information and/or proprietary information accessible by the virtual information presentation system 100 or operators thereof, concerning a user of the virtual information presentation application 220. For example, the virtual information presentation application 220 may search for information concerning educational information, legal information (for example, whether the user has been involved in legal activity involving particular entities), criminal information, relationship information (for example, through social networking services), or the like. In some embodiments, the virtual information presentation application 220 may store at least some of the located information in the system databases 215.

The virtual information presentation application 220 may include various components (or “modules”) to implement the virtual environment and the information presentation process. For instance, the virtual information presentation application 220 may include an information component 225, a natural language processing component 230, an animation engine component 235, a virtual environment component 240, a user input component 245, and an information verification component 250. The components depicted in FIG. 2 are illustrative and non-restrictive. The virtual information presentation application 220 may use more or fewer components than described herein. In addition, the functions of the components described in the embodiments may be performed by one or more components, shared between components, and/or in concert with one or more other applications (for example, a database application, a graphics application, etc.)

In some embodiments, the information component 225 may operate to obtain, manage, and/or provide information associated with an information presentation process. For example, the information component 225 may operate to locate and/or configure the documents, text, multimedia files, and signature blocks that may be required to communicate the required medical information to the patient and to obtain their consent. The information component 225 may obtain the consent information based on various factors, including, without limitation, the medical or research organization, the patient, the medical procedure or clinical study, applicable laws and/or guidelines, and standardized protocols. The information component 225 may obtain the information and/or files for the information presentation process from various sources, such as the system databases 215 or from external storage locations accessible over a network.

According to some embodiments, the information component 225 may dynamically modify the collection of information as the patient progresses through the information presentation process. For instance, the information component 225 may obtain video files responsive to determining that the user prefers to watch videos than to read documents based on patient feedback during the information presentation process. In a non-limiting example, the feedback may be input responsive to a question (for example, “Which do you prefer, videos or text?”) or patient comprehension of presented material (for example, the patient appears to comprehend material presented in textual form better than material presented in video form), such as during the pre-encounter process.

The information obtained and/or generated by the information component 225 may be used by the various elements used during the information presentation process. For example, some of the information may be used to build a script for an avatar, to display text on the display device (for example, displaying all or substantially all medical and/or legal terms), to select elements for display in the virtual environment (for example, elements that make the virtual environment appear like a hospital if the information indicates that the setting of the information presentation process is in a hospital), and combinations thereof.

In some embodiments, the information component 225 may implement a hospital consumer assessment of healthcare providers and systems (HCAHPS) score as part of the evaluation process, for example, by implementing one or more surveys within the system and/or information presentation process.

In some embodiments, the information component 225 may operate to obtain relevant medical information in a thrill suitable for the patient. The selected medical information may be presented based on the health literacy and/or numeracy of the patient. For example, certain low-numeracy individual may have problems understanding percentages. As such, the information component 225 may present such information as a frequency (for example, 5 out of 100) instead of a percentage (5%). In another example, low-numeracy individuals may be presented with graphical information, such as pictures, graphs, pictographs, and/or pictograms configured to convey medical information (for example, such as risk percentages and time information) in a manner that may provide better understanding for low-numeracy individuals. The selection of a particular graphical information component may depend on various factors. For instance, pie graphs may allow for more accurate decisions involving proportions, while a pictograph may better communicate the number of people affected, and not affected, by a medical treatment. The information component 225 may use user input information (described in reference to the user input component 245, below) to determine when to access graphical information and, if so, which type of graphical information may be employed during an information presentation process.

In some embodiments, the information component 225 may obtain information that may be used by the various components of the virtual information presentation application 220 to customize the information presentation process for a particular user or a particular type of user (for instance, based on procedure, demographic information, similarity to past users, or the like). In some embodiments, the information component 225 may obtain the information from the system databases 215 and/or as located by the virtual information presentation application 220 according to some embodiments. In this manner, the information presentation process generated by the virtual information presentation application 220 may be content specific, for example, based on the system user information associated with a user, such as their medical history, demographic information, educational background, vocational background, personal history, legal history, criminal history, relationships, the specific procedure they are undergoing and/or research they are participating in, or any other type of contextual information. In some embodiments, users may enter the system user information through the virtual information presentation application 220. In some embodiments, the virtual information presentation application 220 may determine at least a portion of the system user information, for example, based on publicly available information (for instance, available through the Internet) or based on information stored in the system databases 215.

In some embodiments, the natural language processing component 230 may operate to facilitate natural computer-human interaction during the information presentation process. For example, the natural language processing component 230 may configure certain speech characteristics for an avatar, such as the rate, tone, and volume of the speech, as well as natural responses to patient input. Illustrative natural responses to patient input may include asking a patient if they need help if it appears that they are taking a long time in a particular section, asking whether a user would like to review a topic again if it appears they are having difficulty, and responses to wrong answers. In some embodiments, the natural language processing component 230 may be configured such that the avatar appears to “own” a patient's mistake through responses such as “you did not appear to understand that,” “it's my job to make sure you understand this clearly. Let's try again,” or “maybe I didn't do a good job explaining that point; I'd like to try again.”

In some embodiments, the natural language component 230 may be associated with one or more modules configured to receive speech from the patient and convert it into a digital form functional within the virtual information presentation application 220. For example, a patient may be asked a question by the avatar (for example, “Do you understand this section?”) and the patient may provide a verbal response, such as “yes” or “no.” The natural language component 230 may translate the verbal response into a form acceptable by the virtual information presentation application 220, such as a binary or digital number that may be passed to the module or function that invoked the question and is waiting for a response from the patient. The natural language component 230 may use one or more natural language processing engines known to those haying ordinary skill in the art.

In some embodiments, an animation engine component 235 may operate to generate the animations required for the avatars and any other animated elements in the virtual environment. The animation engine component 235 may be configured to generate life-like avatars capable of realistic, human movement. For example, if the avatar is referring to a document or other object presented on the display device, the animation engine component 235 may animate the avatar to point to the document or other object. Some embodiments provide that the animation engine component 235 may animate an avatar such that it makes typical gesticulations, for example, while talking to the patient. Illustrative gesticulations include pointing, blinking, head movements, hand movements, and smiling.

Some embodiments provide that the animation engine component 235 may generate avatars based on operator instructions, patient input, and/or based on the information compiled by the information component 225. For example, the operator may select certain features of the avatar when generating an information presentation process or a patient may select avatar features at the start of an information presentation process. According to some embodiments, avatar features may include, but are not limited to, age, gender, dress, skin type, height, weight, accent, voice, other physical features (for example, breast size, which may be important in a plastic surgery center that frequently performs breast augmentation surgery), nationality, culture, ethnicity, and position (for example, nurse or general medical staff member). For example, a user may be presented with an interface providing a pre-selected group of pre-programmed options for selecting avatar features.

In addition, the animation engine component 235 may automatically configure certain features based on information such as patient demographic information and/or the site of the information presentation process. For instance, the animation engine component 235 may include certain rules for selecting avatar features based on certain patient information, such as configuring the gender and/or age of the avatar based on the gender and/or age of the patient.

In some embodiments, the virtual environment component 240 may operate to generate the virtual environment for the information presentation process. In general, the virtual environment includes the visual background for the avatar and informed consent information. For example, the virtual environment may be configured to depict a hospital, research facility, or other location. The virtual environment component 240 may generate visual elements, such as GUI components and hyperlinks (for example, links to important medical or legal terms), selected by an operator and/or based on the information compiled by the information component 225. For instance, the virtual environment component 240 may receive instructions from an operator to configure the virtual environment to be personalized to the institutions associated with the information presentation process. In this instance, photographs or computer graphical images of buildings from the site may be integrated into the virtual environment. In another instance, the virtual environment component 240 may be configured to transition between segments (as opposed to jump-cut editing) with topic headings to signify what is being discussed. In a further instance, the virtual environment component 240 may be configured to provide a progress bar indicating progress through the information presentation process.

Some embodiments provide that the virtual environment component 240 may operate to provide virtual selection buttons and visual cues to a patient interacting with the virtual information presentation system 100. For example, the virtual environment component 240 may render “Yes” and “No” buttons on a display device in response to the avatar asking the patient a yes/no question. The patient may select from the buttons using an appropriate input device. In another example, the virtual environment component 240 may change the background of the virtual environment or highlight one or more documents as the information presentation processes advances. In an additional example, the virtual environment component 240 may provide a “pause” button to allow a patient to pause the information presentation process. In a further example, the virtual environment component 240 may provide “rewind,” “replay” and similar playback buttons that allow a patient to move through the information presentation process.

In some embodiments, the virtual environment component 240 may provide a frequently asked questions (FAQ) section or screen and/or one or more “help” buttons to assist the user during the information presentation process. The FAQ screen may provide an interface displaying common questions and their corresponding answers. In some embodiments, answers to the FAQs may be delivered by an avatar responsive to being asked by a user. If a user cannot find the answer to their question in the FAQ screen, they may select the help button or save the question for the doctor or staff member. The help button may provide a more detailed explanation of an active segment and/or summon a staff member for assistance.

In some embodiments, the FAQ screen may be customized for each individual user and/or type of user based on information associated therewith. For instance, the questions (or “FAQs”) presented on the FAQ screen may be customized based on a user's information and/or situation for using the virtual information presentation system (for example, surgery, type of surgery, clinical trial, type of clinical trial, or the like). Accordingly, in some embodiments, not all users will be presented with the same FAQs. In some embodiments, the virtual environment component 240 may track various aspects relating to the FAQs, including, without limitation, which FAQs are used most often, least often, with what frequency, and/or the like. In this manner, the virtual environment component 240 may cycle questions which are never asked out of circulation and present more relevant FAQs to users.

In some embodiments, patients may “ask” questions via selection elements related to one or more categories of pre-configured categories, including, without limitation, “pain,” “scars,” “recovery time,” and “more details.” Each pre-configured category may include a series of pre-configured questions, such as “How long will my scars be” for the scars category or “How much pain will I encounter during recovery” for the pain category. One or more answers may be configured for each question. The answers may be delivered by the avatar responsive to being asked by a user. In this manner, the avatar may appear to interact with the user in a life-like question and answer event. The questions and answers may be stored within the virtual information presentation system 100 and viewed by the doctor (or other professional) before interacting with the patient, for example, in a report or through viewing a recording of the information presentation process. In this manner, the doctor may be aware of some of the issues concerning the patient before interacting with them.

Some embodiments provide that that virtual environment component 240 may provide a bookmark system for patients to mark segments of the information presentation process. For example, a patient may mark a segment that they would like to speak to a doctor about. In some embodiments, the virtual information presentation system 100 may generate a report to the doctor, clinical director, and the like, which may contain the bookmarks.

Some embodiments provide that the virtual environment component 240 may render medical images for display to the patient. For example, the virtual environment component 240 may provide computer generated images for certain explicit material (for example, images from actual surgeries, body parts, injuries, and the like), real photographic images for before and after pictures (for example, good, bad, and excellent plastic surgery results), and scars. Users may be provided an option as to whether or not they prefer to see real photographs or just computer-generated images.

In some embodiments, the user input component 245 operates to receive and manage user input. As described herein, user input may include audio, video, stylus, mouse, keyboard, and touch screen input. The user input component 245 monitors for input and appropriately processes the input according to the state of the information presentation process. For example, if the user makes a touch screen gesture selecting an answer to a question, the user input component 245 may operate to process the user input such that the virtual information presentation application 220 may evaluate the question. In some embodiments, the user input component 245 may operate to monitor that amount of time that a patient spends on each segment and how many times that a patient viewed each segment. According to some embodiments, the user input component 245 may monitor for the user to make an affirmative selection through a virtual button or other GUI component (for example, through a “next” button) before moving to a subsequent segment. In some embodiments, the virtual information presentation system 100 may include a module or device capable of interpreting video input, such as head nods, hand gestures, the presence or absence of movement, or the like.

According to some embodiments, the user input component 245 may operate to handle patient error or lack of responsiveness. For example, if a patient stays on a particular segment too long, the virtual information presentation application 220 may implement a notice to the patient, such as a prompt asking if the user is having difficulty with the segment. Some embodiments provide for time guidelines for certain segments and/or for the entire information presentation process. For example, the optimal time for the information presentation process may be set to be from about fifteen minutes to about twenty minutes.

In some embodiments, the user input component 245 may receive a presentation response from a user. In some embodiments, the presentation response may include an acknowledgement, indication of understanding, consent, user signature, permission, or other response from a user associated with the purpose of the information presentation process. For example, if the information presentation process is configured to obtain consent from a user for a medical procedure, the presentation response would include the consent. In another example, if the information presentation process is configured to obtain acknowledgment of understanding of a process, system, or the like (for instance, as part of an employee training program), then the presentation response may include an indication of understanding from the user. In some embodiments, the presentation response may include one user input (for instance, selection of a “consent” element or other indication of consent at the conclusion of the information presentation process) or multiple user inputs (for instance, answers to a series of questions indicating and/or testing user's understanding of information presented in the information presentation process). In some embodiments, the virtual information presentation application 220 may be configured to process the presentation response, for instance, whether a user selected a GUI element or answered certain presentation response questions correctly. In some embodiments, the virtual information presentation application 220 may store the presentation response for review by an overseer of the information presentation process, such as a doctor, teacher or the like.

In some embodiments, the user input component 245 may operate to receive and store user input as part of a feedback and metrics system. The user input information may be collected and analyzed to examine virtual information presentation system 100 performance and the performance of individual information presentation processes. For example, for a given information presentation process, which part of the process gets replayed the most, which quiz questions are usually answered incorrectly, which processes seem to take the most time, where is that time spent, or the like. In some embodiments, the user input information may further be analyzed based on patient characteristics, such as gender, culture, age, education, and health history.

The virtual information presentation application 220 may operate to provide one or more reports that include the user input information and analysis thereof. For example, an operator or medical staff member may generate a report presenting information associated with two information presentation process for the same medical procedure to determine whether one presentation process is preferable over the other (for example, based on time information or patient error rates).

In some embodiments, the information verification component 250 may operate to verify user interactions with the virtual information presentation system 100. For example, the information verification component 250 may verify that a user was presented with certain information or that a user selected the right answer to a question.

In some embodiments, the information verification component 250 may operate to verify an informed consent provided by a patient through the virtual information presentation system 100. For example, the user may be asked during the information presentation process to answer certain questions to gauge, among other things, their understanding of the material. The informed consent verification component 250 may continually review these answers to verify user understanding. In another example, the informed consent verification component 250 may determine whether the user adequately “signed” (for example, using video, voice, or input gesture) the consent or portions thereof. At the end of the information presentation process, or based on user request, the informed consent verification component 250 may generate one or more reports, as described above in reference to the virtual environment component 240. The reports may provide information about the patient's information presentation process, such as compliance issues, how the patient did during the information presentation process (for example, answers to questions, time information, etc.), patient questions, patient performance information, whether the patient provided consent, and a record of the actual consent. The report and any information associated therewith may be stored within the illustrative virtual information presentation system 100 or a data storage location accessible by the illustrative virtual information presentation system (for example, a PACS system) and may be associated with patient records.

In some embodiments, the informed consent verification component 250 may provide segment knowledge assessments, for example, periodically during the information presentation process or, alternatively, once at the end. If a user fails a test during the information presentation process, the informed consent verification component 250 may invoke the virtual information presentation application 220 to play the segment again. Some or all of the material in the failed segment may be paraphrased in an effort to improve patient comprehension. In some embodiments, the informed consent verification component 250 may require that a patient read aloud certain text of the consent, such as important medical or legal language, as part of the consent verification process.

Some embodiments provide that patients, doctors, medical staff, and other parties may “sign” (or “digitally sign”) the consent using various methods. For example, the patient may be prompted to speak their name or say one or more words (for example, “yes,” “I consent,” or the like), sign with a stylus, make a selection with a mouse or touch screen gesture, make a keyboard selection, or some other selection method. According to some embodiments wherein a user may verbally consent, the virtual information presentation application 220 may utilize the natural language component 230 to provide a verbal signature. Some embodiments provide that the patient may sign the consent in a suitable manner that complies with applicable laws and/or guidelines. The signatures may be stored, for example, as digital files, within the virtual information presentation system 100, healthcare information system, other data storage location, or the like, or any combination thereof.

In some embodiments, consent may include a valid signature by the patient, by the patient and a doctor (or other authorized medical or clinical organization representative), by the patient and their guardian (for example, if the age of the patient is below the level required for consent or if the patient has other reasons why they require a guardian signature), by the patient, the patient's guardian, by an authorized medical or clinical organization representative, and the like.

In general, the informed consent verification component 250 may be configured to ensure that a patient receives full disclosure and understands the undertaking of the medical procedure or clinical study, that the understanding is verified, and that realistic patient expectations are set forth (for example, that the patient is made aware that there are no guarantees of success or a particular result, the probabilities of certain events or results, or the like). The informed consent verification component 250 may additionally provide important material, such as general expectations for the procedure or clinical study that are not legally required, but, nonetheless, may be just as important to a patient.

FIG. 3 depicts illustrative avatars according to some embodiments. As shown in FIG. 3, the avatars 301-306 may be configured as life-like representations of actual persons. The avatars 301-306 may be configured with different characteristics, including, without limitation, clothes, hair, skin tones, facial expressions, personal histories, personalities, and backgrounds. In this manner, the avatars 301-306 within the virtual information presentation system may operate to establish trust and develop a therapeutic alliance between the patient and the avatar 301-306, especially as the user progresses through the information presentation process. The avatars 301-306 may be configured to provide flexibility while maintaining consistency in presentation, invoke empathy and build trust, use non-verbal cues (for example, facial expressions, body language, and other cognitive cues), and may be customized to fill individualized needs.

Some embodiments provide that an avatar 301-306 may be configured to project certain characteristics that may have an effect on the patient. For example, the avatar 301-306 may be configured to be empathetic, to be an independent patient advocate, ombudsperson, part of the doctor's team, to put the patient at ease about the information presentation process (for example, that they are not being rushed), and to provide next steps (for example, stating that “your doctor will answer any questions that I can't” to let the patient know that the doctor will be coming in to see them later the encounter). The avatars 301-306 may be configured to project that they are the hosts of the encounter, for example, by narrating how to use the system and pointing out virtual environment components (for example, buttons, input devices, or the like).

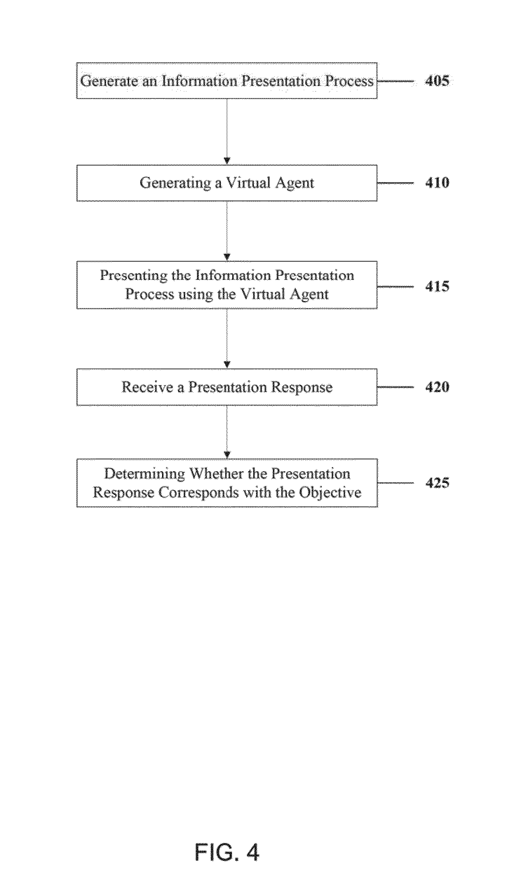

FIG. 4 depicts a flow diagram for an illustrative method for an information presentation process according to some embodiments. As shown in FIG. 4, an information presentation process may be generated 405 by a virtual information presentation system. For instance, an information presentation process may be generated based on an objective, a subject and/or user information. In a non-limiting example, an information presentation process may be configured with an objective of obtaining consent from a patient for a medical procedure. The subject may be a description of the medical procedure, potential outcomes of the medical procedure and/or information associated with providing consent for the medical procedure. The information presentation process may be configured for a user having low health literacy based on user information associated with the user. In another non-limiting example, the information presentation process may be configured with an objective of training user and determining whether the user understood training information presented during the information presentation process.

A virtual agent may be generated 410 by the virtual information presentation system. In some embodiments, the characteristics of the virtual agent, such as age, gender, occupation, clothing, voice, or the like, may be configured based on the subject and/or the user information. The virtual agent may present 415 the information presentation process. In a medical procedure example, the virtual agent may describe the medical procedure and may present images or other information to the user associated with the medical procedure, the healthcare professionals that will be performing the procedure, the healthcare facility, or the like.

The virtual information presentation system may receive 420 a presentation response from a user. In a medical procedure consent example, the presentation response may include an indication as to whether the user consents to the medical procedure. In an employee training example, the presentation response may include answers to questions asked during the information presentation process to indicate whether the user understood the provided information. The virtual information presentation system may determine 425 whether the presentation response corresponds with the objective. In a clinical research consent example, the virtual information presentation system may determine 425 whether the user gave consent to participate in the clinical research. In a job safety training example, the virtual information presentation system may determine 425 whether the user answered all or a certain number of questions relating to the conveyed job safety information correctly.

### EXAMPLE: MEDICAL PROCEDURE INFORMED CONSENT

A virtual information presentation system is configured as a medical procedure informed consent system (“consent system”) at a healthcare facility. An informed consent information presentation process (“consent process”) is generated to provide information associated with a medical procedure to obtain informed, legally defensible informed consent from the user to undergo the medical procedure. User accounts are created in the consent system for potential participants.

A user logs into the consent system using a web-based application on a computing device in a patient room at the healthcare facility, and the consent process is initiated. The consent process starts with a pre-test phase in which the user undergoes an assessment of their cognitive and physical abilities to use the consent system. If the user passes the pre-test, the consent process continues; otherwise, the consent process is stopped, and healthcare facility professionals are alerted via email. The user is presented with an array of available avatars, and the user selects an avatar and characteristics of the avatar. The consent presentation continues as presented by the avatar.

The user is asked to confirm the proposed procedure by selecting an area of the body on an anatomical model and by picking from a list of available procedures. The patient is asked to confirm their past medical history, surgical history, current and past prescriptions, and anesthesia history.

The user's computing device includes a camera and microphone. The user is asked permission to record the image and voice of the user during the consent process, and the user agrees.

The consent process continues by providing a graphical representation of the operating room, post-anesthesia care unit (PACU), surgical process, and time expectations. The consent process identifies physician and other medical staff members that will participate in the medical procedure. The user is asked to acknowledge and consent to the possibility that additional medical professionals and students may observer and/or participate in the medical procedure.

Risk, benefits and alternatives of the proposed medical procedure are presented through the consent process by avatar-guided narration, photographs, illustrations, videos, and animated graphs.

The user is presented with a first patient acquisition of knowledge (AOK) test based on information presented during the consent process. If the user fails all or a portion of the first AOK, the consent process returns to the beginning of the consent process or the failed portion of the consent process. If the user passes the first AOK, the consent process continues.

The consent process presents the user with medical procedure expectations, including, expectations relating to pain, scarring, bleeding, sutures, analgesic use, and returning to normal activities and work.

The user is presented with a second AOK based on information presented since the first AOK. If the user fails all or a portion of the second AOK, the consent process returns to the failed portion of the consent process. If the patient passes the second AOK, the consent process continues.

The consent process presents a detailed explanation and presentation of expected results from the medical procedure. The detailed explanation and presentation includes disclaimers such as not guaranteeing of results, a potential for an extension of procedures based on exigent circumstances, disposal of tissue, and photography.

A detailed presentation of legally required statements are presented, which will form the basis of the actual consent to the medical procedure. The text of the legally required statements will be spoken on-screen by the avatar and duplicated with written on-screen presentation of the same text.

The user is presented with a third AOK based on information presented since the second AOK. If the user fails all or a portion of the third AOK, the consent process returns to the failed portion of the consent process. If the patient passes the third AOK, the consent process continues.

The consent process provides a FAQ screen so that the user can ask questions through a series of topic and category selections. Answers are provided by the avatar, using audio, video, graphics, photographs, or the like as necessary. The consent system monitors which questions are selected to remove low-frequency selections from the set of questions. When the user is finished he may select a “no more questions” button.

The consent process is stopped and a report on the user's interaction with the consent system during the consent process is generated and sent to a physician. The physician speaks with the user during a live session, captured using the computing device's camera, in the patient room. The user is able to have a final question-and-answer session with the physician, including whether the patient has any other questions that the consent process did not address.

The user is asked to affirmatively state the following legally required Statements: (a) they do not have any additional questions, (b) all questions were answered to his satisfaction, (c) lack of coercion, (d) understanding of the content of the consent presentation and the physican's answers to the user's questions.

The user provides an electronic signature using an electronic signature device under the legally required statements. The physician provides an electronic countersignature as provider of the information and as a witness to the consent provided by the user. The user is offered electronic and paper copies of various elements of the recorded consent process.

FIG. 5 depicts illustrative computing device internal hardware according to some embodiments that may be used to contain or implement program instructions, such as the program instructions to implement the virtual information presentation application according to some embodiments. The computing device 500 may be a client computing device or server computing device. The computing device 500 may include a bus 560 that serves as the main information highway interconnecting the other illustrated components of the hardware. CPU 505 is the central processing unit of the system, performing calculations and logic operations required to execute a program. CPU 505, alone or in conjunction with one or more of the other elements disclosed in FIG. 5, is an exemplary processing device, computing device or processor as such terms are used within this disclosure. Read only memory (ROM) 510 and random access memory (RAM) 515 constitute exemplary memory devices (i.e., processor-readable non-transitory storage media).

A controller 520 interfaces with one or more optional memory devices 525 to the system bus 560. These memory devices 525 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 510 and/or the RAM 515. Optionally, the program instructions may be stored on a tangible computer readable medium such as a compact disk, a digital disk, flash memory, a memory card, a USB drive, an optical disc storage medium, such as a Blu-ray™ disc, and/or other non-transitory storage media.

An optional display interface 530 may permit information from the bus 560 to be displayed on the display 535 in audio, visual, graphic or alphanumeric format. Communication with external devices, such as a print device, may occur using various communication ports 540. An exemplary communication port 540 may be attached to a communications network, such as the Internet or an intranet.

The hardware may also include an interface 545 which allows for receipt of data from input devices such as a keyboard 550 or other input device 555 such as a mouse, a joystick, a touch screen, a remote control, a pointing device, a video input device and/or an audio input device.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling, the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A virtual information presentation system, comprising
a processor; and
a non-transitory, computer-readable storage medium in operable communication with the processor, wherein the computer-readable storage medium contains one or more programming instructions that, when executed, cause the processor to:
generate an information presentation process comprising a plurality of information elements, the information presentation process being configured based on an objective and at least one subject,
generate at least one virtual agent comprising at least one virtual agent characteristic, the at least one virtual agent characteristic being configured based on at least one of the objective and the at least one subject,
present the information presentation process using the virtual agent, and
receive user input comprising at least one presentation response.

2. (canceled)

3. (canceled)

4. The system of claim 1, wherein at least one of the at least one virtual agent characteristic and the information presentation process is configured based on system user information received by the processor.

5. (canceled)

6. The system of claim 1, wherein the objective comprises at least one of user consent and demonstration of understanding by a user.

7. The system of claim 1, wherein the subject comprises at least one of a medical procedure and a clinical research project.

8. (canceled)

9. (canceled)

10. The system of claim 1, wherein the subject comprises a medical procedure, and wherein the objective comprises consent to undergo the medical procedure.

11. The system of claim 1, wherein the subject comprises a clinical research project, and wherein the objective comprises consent to participate in the clinical research project.

12. The system of claim 1, wherein the one or more programming instructions, when executed, further cause the processor to modify at least one of the information presentation process and the at least one virtual agent characteristic based on the user input.

13-17. (canceled)

18. A computer-implemented method for presenting an information presentation process to a system user, the method comprising, by a processor:
generating an information presentation process comprising a plurality of information elements, the information presentation process being configured based on an objective and at least one subject;
generating at least one virtual agent comprising at least one virtual agent characteristic, the at least one virtual agent characteristic being configured based on at least one of the objective and the at least one subject;
presenting the information presentation process using the virtual agent; and receiving user input comprising at least one presentation response.

19. (canceled)

20. (canceled)

21. The method of claim 18, wherein at least one of the at least one virtual agent characteristic and the information presentation process is configured based on system user information.

22. (canceled)

23. The method of claim 18, wherein the objective comprises at least one of consent and demonstration of understanding.

24. The method of claim 18, wherein the subject comprises at least one of a medical procedure and a clinical research project.

25. (canceled)

26. (canceled)

27. The method of claim 18, wherein the subject comprises a medical procedure, and wherein the objective comprises consent to undergo the medical procedure.

28. The method of claim 18, wherein the subject comprises a clinical research project, and wherein the objective comprises consent to participate in the clinical research project.

29. The method of claim 18, further comprising modifying at least one of the information presentation process and the at least one virtual agent characteristic based on the user input.

30-34. (canceled)

35. A computer-readable storage medium having computer-readable program code configured to present an information presentation process embodied therewith, the computer-readable program code comprising:
computer-readable program code configured to generate at least one virtual agent comprising at least one virtual agent characteristic, the at least one virtual agent characteristic being configured based on at least one of the objective and the at least one subject;
computer-readable program code configured to present the information presentation process using the virtual agent; and
computer-readable program code configured to receive user input comprising at least one presentation response.

36. (canceled)

37. (canceled)

38. The computer-readable storage medium of claim 35, further comprising computer readable program code configured to configure at least one of the at least one virtual agent characteristic and the information presentation process is configured based on system user information.

39. (canceled)

40. The computer-readable storage medium of claim 35, wherein the objective comprises at least one of user consent and demonstration of understanding by a user.

41. The computer-readable storage medium of claim 35, wherein the subject comprises at least one of a medical procedure and a clinical research project.

42-45. (canceled)

46. The computer-readable storage medium of claim 35, further comprising computer readable program code configured to modify at least one of the information presentation process and the at least one virtual agent characteristic based on the user input.

47. (canceled)

48. The computer-readable storage medium of claim 35, further comprising computer readable program code configured to record at least one of the presentation of the information presentation process, a user being presented with the information presentation process, and the user input.

49-60. (canceled)
